(19) United States
(12) Patent Application Publication
(10) Pub. No.: US 2016/0100707 A1
(43) Pub. Date: Apr. 14, 2016

(54) Rice Cooker

(71) Applicant: ZHEJIANG SUPOR ELECTRICAL APPLIANCES MANUFACTURING CO., LTD., Hangzhou, Zhejiang (CN)

(72) Inventor: Qun Huang, Hangzhou (CN)

(21) Appl. No.: 14/890,729

(22) PCT Filed: Jan. 24, 2014
(86) PCT No.: PCT/CN2014/071348

§ 371 Date: Nov. 12, 2015

(30) Foreign Application Priority Data
May 13, 2013 (CN) 201310176829.2

(51) Int. Cl. A47J 27/04

(52) U.S. Cl. CPC A47J 27/04; A47J 2027/043

(57) ABSTRACT

The present invention provides a rice cooker which comprises an inner pot, an inner lid, and a first elastic seal ring, the inner lid is snapped on the inner pot to enclose a pot cavity, the first elastic seal ring is disposed at the periphery of the inner lid to seal the gap between the inner lid and the inner pot when the inner lid is snapped on the inner pot, the inner lid comprises an inner surface facing the pot cavity and an outer surface disposed opposite to the inner surface, and the inner lid is provided with an exhaust through hole passing through the inner surface and the outer surface. The rice cooker further comprises an exhaust through hole sealing means comprising an elastic sealing disk which is attached on the outer surface of the inner lid and covers the exhaust through hole. When the difference between the internal air pressure and the external air pressure of the pot cavity is less than a first pressure difference, the elastic sealing disk seals the exhaust through hole, and when the difference is greater than the first pressure difference, the elastic sealing disk releases the sealing of the exhaust through hole.

The present invention relates to the field of household appliances, and more particularly to a rice cooker.

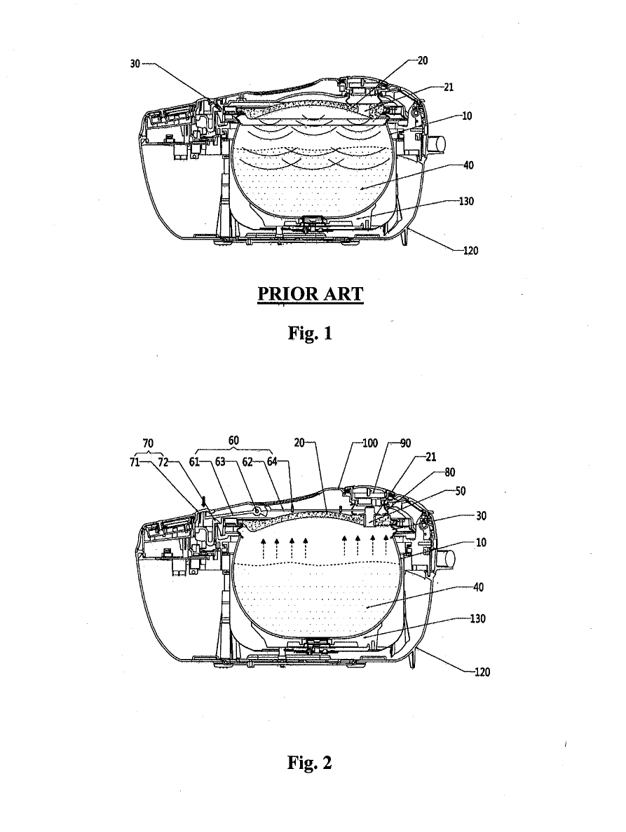

It is already known that a rice cooker has a similar structure as that of the rice cooker described in CN1498572A. As shown in FIG. 1, this known rice cooker generally comprises an outer pot 120, a heating plate 130, an inner pot 10, an outer lid, an inner lid 20, an exhaust valve assembly, a first elastic seal ring 30 and second elastic seal ring. The inner lid 20 is snapped on the inner pot 10 to enclose a pot cavity 40. The first elastic seal ring 30 is disposed at the periphery of the inner lid 20 to seal the gap between the inner lid 20 and the inner pot 10 when the inner lid 20 is snapped on the inner pot 10. The inner lid 20 comprises an inner surface facing the pot cavity 40 and an outer surface disposed opposite to the inner surface, and the inner lid 20 is provided with an exhaust through hole 21 passing through the inner surface and the outer surface. The inner lid 20 is connected to the inner side of the outer lid. The exhaust valve assembly is disposed on the outer lid. The second elastic seal ring is disposed between the outer lid and the inner lid 20 and is hermetically disposed around the peripheries of the inlets of the exhaust through hole 21 and the exhaust valve assembly.

In the course of carrying out the present invention, the inventors have found that the above prior art has at least the following disadvantage: after the food is cooked, since the pot cavity 40 is in communication with the atmosphere through the exhaust through hole 21 and the exhaust valve assembly, air enters the interior of the pot cavity 40 quickly, thus it is difficult to keep warm and fresh of the food in the rice cooker.

The object of the present invention is to provide a rice cooker which can lengthen the incubation and freshness time of the food within the rice cooker after the food is cooked by the rice cooker.

In order to achieve the above object, the present invention provides a rice cooker which comprises an inner pot, an inner lid and a first elastic seal ring, the inner lid is snapped on the inner pot to enclose a pot cavity, the first elastic seal ring is disposed at the periphery of the inner lid to seal the gap between the inner lid and the inner pot when the inner lid is snapped on the inner pot, the inner lid comprises an inner surface facing the pot cavity and an outer surface disposed opposite to the inner surface, and the inner lid is provided with an exhaust through hole passing through the inner surface and the outer surface. The rice cooker further comprises an exhaust through hole sealing means comprising an elastic sealing disk which is attached on the outer surface of the inner lid and covers the exhaust through hole. When the difference between the internal air pressure and the external air pressure of the pot cavity is less than a first pressure difference, the elastic sealing disk seals the exhaust through hole, and when the difference is greater than the first pressure difference, the elastic sealing disk releases the sealing of the exhaust through hole. In a preferred embodiment, the first pressure difference is greater than or equal to zero.

According to another aspect, the exhaust through hole sealing means further comprises a connection part respectively connected to the elastic sealing disk and the inner lid to prevent the elastic sealing disk from being disengaged from the inner lid.

According to another aspect, the connection part comprises: a connecting post which is positioned in the exhaust through hole, a vent passage being formed between the connecting post and the exhaust through hole, the elastic sealing disk being disposed on the first end of the connecting post; a limit part which is positioned in the pot cavity and disposed on the second end of the connecting post, the distance between at least part of the outer edge of the limit part and the central axis of the exhaust through hole being greater than the radius of the exhaust through hole, and a vent port in communication with the exhaust through hole being provided between the limit part and the inner lid.

According to another aspect, there's a clearance fit between the connecting post and the exhaust through hole, the gap between the connecting post and the exhaust through hole forms the vent passage.

According to another aspect, the limit part is a male ring disposed on the second end of the connecting post, a spacing which forms the vent port is provided between at least a part of the male ring closest to the surface of the inner lid and the inner surface of the inner lid.

According to another aspect, the rice cooker further comprises an operating mechanism which comprises an operating part and has a non-working position and a working position, wherein, in the non-working position, the operating part is separated from the exhaust through hole sealing means; in the working position, the operating part cooperates with the exhaust through hole sealing means, and the elastic sealing disk releases the sealing of the exhaust through hole under the combined action of the operating part and the aforementioned difference.

According to another aspect, the exhaust through hole sealing means further comprises a bump provided on one side of the elastic sealing disk away from the inner lid; the rice cooker further comprises an operating mechanism which comprises an operating part and has a non-working position and a working position; wherein, in the non-working position, the operating part is separated from the exhaust through hole sealing means; in the working position, the operating part is pressed against the bump of the exhaust through hole sealing means, and the bump which is under the action of the operating part and the aforementioned difference brings at least part of the separation of the elastic sealing disk from the outer surface of the inner lid to releases the sealing of the exhaust through hole.

According to another aspect, the rice cooker further comprises a locking part interlinked with the operating mechanism, the locking part has a locking position and an unlocking position, wherein, in the locking position, the inner lid and the inner pot are in a snap-locked status, and the operating mechanism is in the non-working position; in the unlocking position, the inner lid and the inner pot are in a released snap-locked status, and the operation mechanism is in the working position.

According to another aspect, the locking part comprises a button interlinked with the operating mechanism and a latch connected to and driven by the button, the button has a free status and a pressed status, wherein, in the free status, the locking part is in the locking position, the latch keeps the inner lid and the inner pot in the snap-locked status; in the pressed status, the locking part is in the unlocking position, the latch keeps the inner lid and the inner pot in the released snap-locked status.

According to another aspect, the operation mechanism comprises: a first connecting rod which comprises a first end and a second end oppositely disposed and a hinge part disposed therebetween, the first connecting rod being rotatably disposed about the hinge part relative to the inner lid, wherein, the first end of the first connecting rod is disposed under the button, abutting against and cooperating with the button; a second connecting rod which comprises a first end and a second end oppositely disposed, the first end of the second connecting rod abutting against and cooperating with the second end of the first connecting rod, the second connecting rod under the driving of the second end of the first connecting rod being translatably disposed relative to the inner lid along along with the rotation of the first connecting rod, wherein, the second end of the second connecting rod forms the operating part.

According to another aspect, the second end of the first connecting rod comprises an outwardly convex curved surface; the first end of the second connecting rod comprises a plane obliquely disposed with respect to the translation direction of the second connecting rod, the plane abutting against and cooperating with the outwardly convex curved surface.

According to another aspect, the rice cooker further comprises: an outer lid, the inner lid being connected to the inner side of the outer lid; an exhaust valve assembly disposed on the outer lid; a second elastic seal ring disposed between the outer lid and the inner lid and is hermetically disposed around the peripheries of the exhaust through hole, the exhaust through hole sealing means and the exhaust valve assembly, the second elastic seal ring comprising a mounting hole; the second connecting rod and the mounting hole of the second elastic seal ring are hermetically engaged.

According to another aspect, the second connecting rod comprises a fixing part disposed between the first end and the second end of the second connecting rod, the second connecting rod is hermetically fixed to the second elastic seal ring by the fixing part.

According to another aspect, the fixing part comprises a first annular part and a second annular part, between which annular parts is disposed the mounting hole of the second elastic seal ring, and the first annular part and the second annular part respectively abut against the second elastic seal ring.

According to another aspect, the rice cooker further comprises a reset mechanism which is drivingly connected to the operating mechanism and used for driving the operating mechanism to return to the non-working position from the working position.

According to another aspect, the first elastic seal ring is configured to produce a deformation making the difference between the internal air pressure and the exterior air pressure of the pot cavity greater than the first pressure difference as the inner lid is snapped on the inner pot.

For the rice cooker according to the present invention, due to the exhaust through hole sealing means provided at the exhaust through hole of the inner lid, when the food is cooked, as vapor is continuously produced within the pot cavity, the difference between the internal air pressure and the external air pressure of the pot cavity is greater than the first pressure difference, the sealing of the exhaust through hole is released by the elastic sealing disk, thereby the gas in the pot cavity is discharged; after the food is cooked, when the difference between the internal air pressure and the external air pressure of the pot cavity gradually decreases to less than the first pressure difference, the exhaust through hole is sealed by the elastic sealing disk, the air cannot enter the pot cavity, allowing the food within the pot cavity to be isolated from the air, thus the incubation and freshness time of the food within the pot cavity can be lengthened.

The drawings constituting a part of this application are used to provide a further understanding of the present invention, the illustrative embodiments of the present invention and description thereof serve to explain the present invention and are not to be construed as unduly limiting the present invention. In the drawings:

FIG. 1 is a schematic diagram of the structure of the prior art rice cooker;

FIG. 2 is a schematic diagram of the structure of the rice cooker according to an embodiment of the present invention;

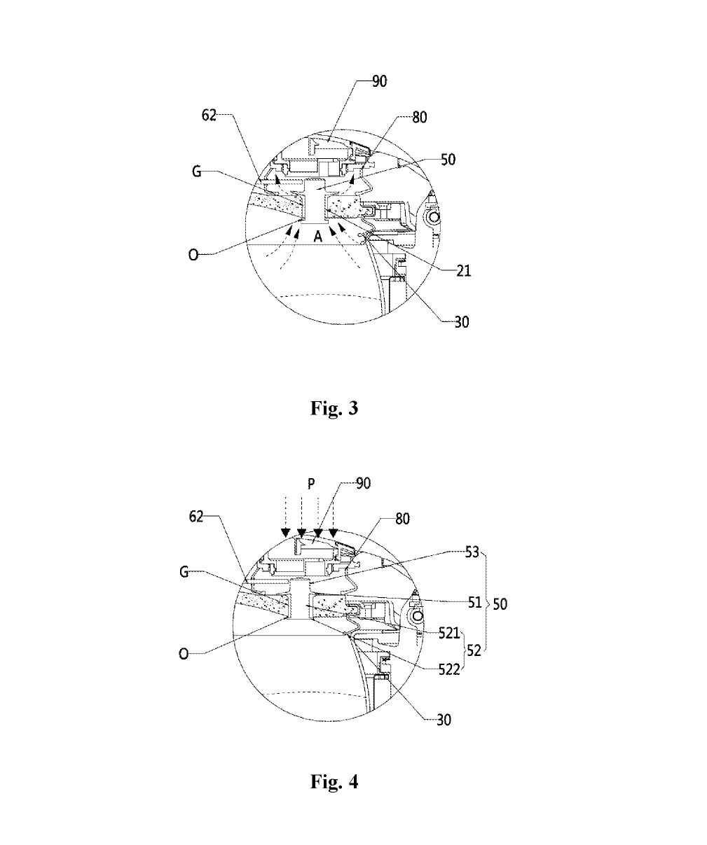

FIG. 3 is a partially enlarged schematic diagram of the structure of the rice cooker of FIG. 2 when the exhaust through hole sealing means is in an exhausting status as the rice cooker is snapped or the food is cooked;

FIG. 4 is a partially enlarged schematic diagram of the structure of the rice cooker of FIG. 2 when the exhaust through hole sealing means is in a sealing status after the food is cooked;

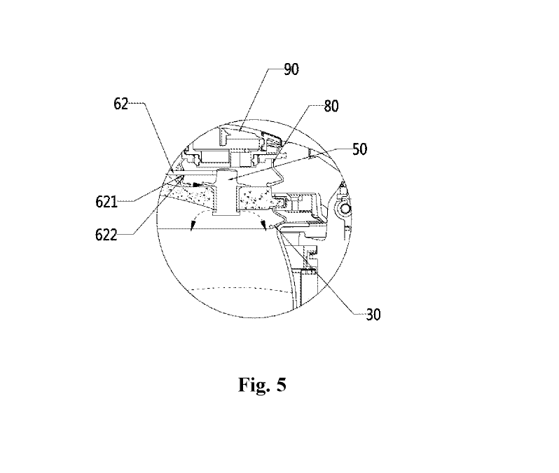

FIG. 5 is a partially enlarged schematic diagram of the structure of the rice cooker of FIG. 2 after the exhaust through hole sealing means is driven by the operating mechanism to transfer from the sealing status to the exhausting status.

The present invention will now be explained in detail with reference to the drawings and in connection with the embodiments. It is to be noted that the embodiments in the present application and the features in the embodiments may be combined with one another in case of no conflict.

As shown in FIG. 2 to FIG. 5, the rice cooker according to an embodiment of the present invention comprises an inner pot 10, an inner lid 20, a first elastic seal ring 30 and an exhaust through hole sealing means 50. The inner lid 20 is snapped on the inner pot 10 to enclose a pot cavity 40. The first elastic seal ring 30 is disposed at the periphery of the inner lid 20 to seal the gap between the inner lid 20 and the inner pot 10 when the inner lid 20 is snapped on the inner pot 10. The inner lid 20 comprises an inner surface facing the pot cavity 40 and an outer surface disposed opposite to the inner surface. The inner lid 20 is provided with an exhaust through hole 21 passing through the inner surface and the outer surface. The exhaust through hole sealing means 50 comprises an elastic sealing disk 51 which is attached on the outer surface of the inner lid 20 and covers the exhaust through hole 21. When the difference between the internal air pressure and the external air pressure of the pot cavity 40 is less than a first pressure difference, the elastic sealing disk 51 seals the exhaust through hole 21, and when the difference is greater than the first pressure difference, the elastic sealing disk 51 releases the sealing of the exhaust through hole 21, wherein the first pressure difference is greater than or equal to zero.

For the rice cooker according to the present invention, due to the exhaust through hole sealing means 50 provided at the exhaust through hole 21 of the inner lid 20, when the food is cooked, as vapor is continuously produced within the pot cavity 40, the pressure difference between the internal air pressure and the external air pressure of the pot cavity 40 is greater than the first pressure difference, the sealing of the exhaust through hole 21 is released by the elastic sealing disk 51, thereby the gas in the pot cavity 40 is discharged; after the food is cooked, when the pressure difference between the internal air pressure and the external air pressure of the pot cavity 40 gradually decreases to less than the first pressure difference, the exhaust through hole 21 is sealed by the elastic sealing disk 51, the air cannot enter the pot cavity 40, allowing the food within the pot cavity 40 to be isolated from the air, thus the incubation and freshness time of the food within the pot cavity 40 can be lengthened.

Embodiments of the present invention will be described in detail below with reference to FIG. 2 to FIG. 5.

As shown in FIG. 2, the rice cooker of the present embodiment comprises an outer pot 120, a heating plate 130, an inner pot 10, an outer lid 100, an inner lid 20, an exhaust valve assembly 90, a first elastic seal ring 30 and second elastic seal ring 80, an exhaust through hole sealing means 50, a locking part 70 and an operating mechanism 60. The inner lid 20 is connected to the inner side of the outer lid 100. The inner lid 20 is snapped on the inner pot 10 to enclose a pot cavity 40. The inner pot 10 is disposed in the outer pot 120 and seated on the heating plate 130. The first elastic seal ring 30 is disposed at the periphery of the inner lid 20 to seal the gap between the inner lid 20 and the inner pot 10 when the inner lid 20 is snapped on the inner pot 10. The inner lid 20 comprises an inner surface facing the pot cavity 40 and an outer surface disposed opposite to the inner surface, and the inner lid 20 is provided with an exhaust through hole 21 passing through the inner surface and the outer surface. The exhaust through hole sealing means 50 comprises an elastic sealing disk 51 for sealing the exhaust through hole 21. When the exhaust through hole 21 is sealed by the elastic sealing disk 51 of the exhaust through hole sealing means 50, the pot cavity 40 forms a closed space and can be isolated from the exterior air.

The exhaust valve assembly 90 is disposed on the outer lid 100. The second elastic seal ring 80 is disposed between the outer lid 100 and the inner lid 20 and is hermetically disposed around the peripheries of the exhaust through hole 21, the exhaust through hole sealing means 50 and the exhaust valve assembly 90. Thus, because of the sealing action of the second elastic seal ring 80, the gas discharged from the pot cavity 40 through the exhaust through hole 21 is directly discharged into the atmosphere through the exhaust valve assembly 90 and will not enter the parts outside the second elastic seal ring 80 between the inner lid 20 and the outer lid 100.

As shown in FIG. 2 to FIG. 5, in this embodiment, the elastic sealing disk 51 may be for example a circular disk with a diameter greater than the diameter of the exhaust through hole 21.

The exhaust through hole sealing means 50 further comprises a connecting part 52 for connecting the elastic sealing disk 51 to the inner lid 20. The connecting part 52 is respectively connected to the elastic sealing disk 51 and the inner lid 20 to prevent the elastic sealing disk 51 from being disengaged from the inner lid 20.

As shown in FIG. 2 to FIG. 5, in this embodiment, the connecting part 52 comprises a connecting post 521 and a limit part.

As shown in FIG. 4, the connecting post 521 is positioned in the exhaust through hole 21 and a vent passage G is provided between the connecting post 521 and the exhaust through hole 21, the elastic sealing disk 51 is disposed on the first end of the connecting post 521.

As shown in FIG. 4, a limit part is positioned in the pot cavity 40 and disposed on the second end of the connecting post 521, the distance between at least part of the outer edge of the limit part and the central axis of the exhaust through hole 21 is greater than the radius of the exhaust through hole 21, and there is a vent port O in communication with the exhaust through hole 21 between the limit part and the inner lid 20.

In this embodiment, the connecting post 521 of the exhaust through hole sealing means 50 may be cylindrical in shape and forms a clearance fit with the exhaust through hole 21, the gap between the connecting post 521 and the exhaust through hole 21 forms the vent passage G. Here, the vent passage G is annular.

In examples not shown, the connecting post 521 can also be a cylinder having a rectangular, elliptical or quincunxial cross-section, among others, and the vent passage G may have other shapes adapted to the cross-sectional shape of the connecting post 521.

In this embodiment, the limit part of the exhaust through hole sealing means 50 is a male ring 522 disposed on the second end of the connecting post 521, and a spacing which forms the vent port O is provided between at least a part of the male ring 522 closest to the surface of the inner lid 20 and the inner surface of the inner lid 20.

In examples not shown, the limit part may have other structures such as a half-ring or a plurality of radial projections as long as it can limit the exhaust through hole sealing means 50 and form the vent port.

As shown in FIG. 2, in this embodiment, preferably, the rice cooker further comprises an operating mechanism 60 which comprises an operating part and has a non-working position and a working position. Wherein, in the non-working position, the operating part is separated from the exhaust through hole sealing means 50; in the working position, the operating part cooperates with the exhaust through hole sealing means 50, and the elastic sealing disk 51 releases the sealing of the exhaust through hole 21 under the combined action of the operating part and the difference between the internal air pressure and the external air pressure of the pot cavity 40. In this embodiment, under the combined action of the operating part and the aforementioned difference, at least part of the separation of the elastic sealing disk 51 from the outer surface of the inner lid 20 is brought to allow the interior of the pot cavity 40 to communicate with the exterior of the pot cavity 40.

In addition, as shown in FIG. 2 to FIG. 5, in this embodiment, the exhaust through hole sealing means 50 also comprises a bump 53 provided on one side of the elastic sealing disk 51 away from the inner lid 20. In the working position of the operating mechanism 60, the operating part of the operating mechanism 60 is pressed against the bump 53 of the exhaust through hole sealing means 50, and the bump 53 which is under the combined action of the operating part and the aforementioned difference brings at least part of the separation of the elastic sealing disk 51 from the outer surface of the inner lid 20, thus allowing the interior of the pot cavity 40 to communicate with the exterior of the pot cavity 40.

As shown in FIG. 2, the rice cooker in this embodiment further comprises a locking part 70 interlinked with the operating mechanism 60, the locking part 70 has a locking position and an unlocking position. In the locking position, the inner lid 20 and the inner pot 10 are in a snap-locked status, and the operating mechanism 60 is in the non-working position; in the unlocking position, the inner lid 20 and the inner pot 10 are in a released snap-locked status, and the operation mechanism 60 is in the working position.

As shown in FIG. 2, the locking part 70 comprises a button 71 interlinked with the operating mechanism 60 and a latch 72 connected to and driven by the button 71, the button 71 has a free status and a pressed status. When the button 71 is in the free status, the locking part 70 is in the locking position, the latch 72 keeps the inner lid 20 and the inner pot 10 in the snap-locked status, at this point, as shown in FIG. 3 and FIG. 4, the operating mechanism 60 is in the non-working position; when the button 71 is in the pressed status, the locking part 70 is in the unlocking position, the latch 72 keeps the inner lid 20 and the inner pot 10 in the released snap-locked status, at this point, as shown in FIG. 5, the operating mechanism 60 is in the working position.

As shown in FIG. 2, in this embodiment, the operating mechanism 60 comprises a first connecting rod 61, a second connecting rod 62, a hinge shaft 63 and a support part 64. The first connecting rod 61 comprises a first end and a second end oppositely disposed. The hinge shaft 63 extends through a hinge part of the first connecting rod 61 which is disposed between the first end and the second end of the first connecting rod 61. The hinge shaft 63 may be disposed on the inner lid 10 or the outer lid 100. The first connecting lid 61 is rotatably disposed about the hinge part relative to the inner lid 20, wherein the first end of the first connecting rod 61 is disposed under the button 71, abutting against and cooperating with the button 71.

The second connecting rod 62 comprises a first end and a second end oppositely disposed. The first end of the second connecting rod 62 abuts against and cooperates with the second end of the first connecting rod 61. The second connecting rod 62 under the driving of the second end of the first connecting rod 61 is translatably disposed relative to the inner lid 20 along with the rotation of the first connecting rod 61, wherein the second end of the second connecting rod 62 forms the operating part. In this embodiment, the operating mechanism comprises two support parts 64, each of which may be positioned on the inner lid 10 or the outer lid 100, the second connecting rod 62 is supported on the two support parts 64, and is slidably disposed along the connection line of the two support parts 64 relative to the support parts 64.

Preferably, in this embodiment, the second end of the first connecting rod 61 comprises an outwardly convex curved surface. The first end of the second connecting rod 62 comprises a plane obliquely disposed with respect to the translation direction of the second connecting rod 62, the plane abuts against and cooperates with the outwardly convex curved surface. In this way, when moving up and down along with the up-and-down movement of the button 71, the second end of the first connecting rod 61 can easily move with respect to the aforementioned plane of the second connecting rod 62, so that the up-and-down movement of the second end of the first connecting rod 61 is transformed into the translational movement of the second connecting rod 62, so as to facilitate the second end of the second connecting rod 62, i.e., the operating part of the operating mechanism 60 to change the relative position with respect to the exhaust through hole sealing means 50.

In this embodiment, in order to prevent the mutual influence between the second elastic seal ring 80 and the operating device 60, the second elastic seal ring 80 comprises a mounting hole; the second connecting rod 62 and the mounting hole of the second elastic seal ring 80 are hermetically engaged.

Wherein, the second connecting rod 62 comprises a fixing part disposed between the first end and the second end of the second connecting rod 62. The second connecting rod 62 is sealedly fixed to the second elastic seal ring 80 by the fixing part.

As shown in FIG. 5, in this embodiment, preferably, the fixing part comprises a first annular part 621 and a second annular part 622, between which annular parts is disposed the mounting hole of the second elastic seal ring 80, and the first annular part 621 and the second annular part 622 respectively abut against the second elastic seal ring 80. Thus, due to the driving action of the pressing force against the button 71 on the operating mechanism 60, the translational movement of the second connecting rod 62 can bring a local elastic deformation of the second elastic seal ring 80, so that the translational movement of the second connecting rod 62 will not be limited by the second elastic seal ring 80.

In this embodiment, upon the pressing force against the button 71 is removed, the driving force of the button 71 against the operating mechanism 60 disappears. Due to the elastic force of the exhaust through hole sealing means 50 and the second elastic seal ring 80, the operating mechanism 60 can automatically return to the non-working position from the working position.

In an embodiment which is not shown, the rice cooker may further comprise a reset mechanism which is drivingly connected to the operating mechanism 60. When the locking part 70 returns to the locking position from the unlocking position, the reset mechanism drives the operating mechanism 60 to return to the non-working position from the working position. For example, the reset mechanism may be a spring, one end of which is connected to the rod body of the second connecting rod 62 disposed between the two support parts 64, and the other end of which abuts against the support part 64 closest to the exhaust through hole sealing means 50.

In this embodiment, the first elastic seal ring 30, the second elastic seal ring 80 and the exhaust through hole sealing means 50 are respectively integrally formed of silicone materials.

Further preferably, the first elastic seal ring 30 is configured to produce a deformation allowing the difference between the internal air pressure and the exterior air pressure of the pot cavity 40 to be greater than the first pressure difference as the inner lid 20 is snapped on the inner pot 10. Thus, as the inner lid 20 is snapped, part of the gas in the pot cavity 40 can be discharged, thus after the inner lid 20 is completely snapped on the inner pot 10, the exhaust through hole 21 can be sealed by the elastic sealing disk 51, so that the interior of the pot cavity 40 is isolated from the exterior of the pot cavity 40, which is helpful for freshness and incubation of the food in the rice cooker.

The operating principle of the rice cooker according to this embodiment will be explained below in connection with FIG. 2 to FIG. 5.

As shown in FIG. 3, when the inner lid 20 of the rice cooker is snapped on the inner pot 10, after the first elastic seal ring 30 abuts against the edge of the inner lid 20, the connection part between the inner lid 20 and the inner pot 10 is sealed. As the inner lid 20 continues to press down towards the inner pot 10, the first elastic seal ring 30 is pressed to deform, the gas in the pot cavity 40 is compressed to the internal air pressure, the difference between the internal air pressure and the exterior air pressure (the atmospheric pressure in this embodiment) overcomes the elastic force of the elastic sealing disk 51. Part of the gas A in the pot cavity 40 flows through the vent port O, the vent passage G, the gap between the elastic sealing disk 51 and the inner lid 20 and the exhaust valve assembly 90 sequentially and then exits until the inner lid 20 is completely snapped on the inner pot 10. Afterwards, the exhaust through hole 21 is sealed by the elastic sealing disk 51, the external air can not enter the pot cavity 40, so that the food in the pot cavity 40 is isolated from the exterior environment.

Similarly, during food cooking, because water vapor is constantly produced in the pot cavity 40. When the pressure of the gas A in the pot cavity 40 overcomes the atmospheric pressure and the elastic force of the elastic sealing disk 51, a gap is formed between the elastic sealing disk 51 and the outer surface of the inner lid 20. At this time, the part of the gas A in the pot cavity 40 flows through the vent port O, the vent passage G, the gap between the elastic sealing disk 51 and the inner lid 20 and the exhaust valve assembly 90 sequentially and then exits. At this point, the button 71 of the locking part 70 is in the free status, the latch 72 makes the inner lid 20 and the inner pot 10 in the snap-locked status, the operating part of the operating mechanism 60, i.e., the second end of the second connecting rod 62 is separated from the bump 53 of the exhaust through hole sealing means 50.

As shown in FIG. 4, after the food is cooked, as the heating plate 130 stops heating the inner pot 10, no gas is newly produced in the pot cavity 40, and the gas in the pot cavity 40 will suffer from thermal expansion and contraction, the pressure in the pot cavity 40 becomes less than the sum of the atmospheric pressure P and the elastic force of the elastic sealing disk 51. Under the combined action of the atmospheric pressure P and the elastic force of the elastic sealing disk 51, the elastic sealing disk 51 is closely overlaid on the outer surface of the inner lid 10, allowing the pot cavity 40 to form a sealed cavity. Thus, the pot cavity maintains a negative pressure status. Since air can not enter the pot cavity 40, the incubation and freshness time of the food within the rice cooker can be lengthened. At this time, the status of the locking part 70 and the operating mechanism 60 are not changed compared with the status shown in FIG. 3.

As shown in FIG. 5, when the lid of the rice cooker is opened, the button 71 of the locking part 70 is pressed to make the button 71 transform from the free status into the pressed status. During this process, on one hand, the button 71 drives the latch 72 to act in order to make the inner lid 20 and the inner pot 10 in the released snap-locked status, on the other hand, the button 71 drives the first end of the first connecting rod 61 to move downwards, causing the first connecting rod 61 to rotate about the hinge shaft 63 and the second end of the first connecting rod 61 to move upwards. The outwardly convex curved surface of the second end of the first connecting rod 61 moves relative to the oblique plane of the first end of the second connecting rod, thus driving the second connecting rod 62 to move towards the exhaust through hole sealing means 50. Finally, the second end of the second connecting rod 62 abuts against the bump 53 and drives the bump 53 to be displaced. Under the driving of the bump 53, the elastic sealing disk 51 is deformed and a gap is formed between the elastic sealing disk 51 and the outer surface of the inner lid 20. At this point, the interior and the exterior of the pot cavity 40 are in communication, so that the exterior air enters the pot cavity 40, resulting in a pressure balance between the interior air pressure and exterior air pressure of the pot cavity 40. The negative pressure status in the pot cavity 40 is released, thus the inner lid 20 and the inner pot 10 can be easily separated from each other.

Since the second connecting rod 62 and the second elastic seal ring 80 are fixed, the movement of the second connecting rod 62 from the first position to the second position will result in a local deformation of the second elastic seal ring 80, i.e., a deformation from the status shown with the dashed line to the status shown with the solid line in FIG. 5. However, due to the elastic effect of the second elastic seal ring 80 itself, this deformation is not sufficient to destroy the original sealing effect of the second elastic seal ring 80.

After the button 71 is released, the operating mechanism 60 automatically returns to the non-working position from the working position under the elastic effects of the exhaust through hole sealing means 50 and the second elastic seal ring 80.

As can be seen from the above description, the following technical effects can be achieved by the embodiment described above:

Due to the exhaust through hole sealing means provided at the exhaust through hole 21 of the inner lid 20, during the food cooking, the pressure of the gas in the pot cavity is greater than the atmospheric pressure and the elastic force of the elastic sealing disk 51, thus the gas in the pot cavity can be discharged by opening the elastic sealing disk 51 of the exhaust through hole sealing means 50. After the food is cooked, when the gas pressure in the pot cavity gradually reduces to a certain extent, the elastic sealing disk 51 is overlaid on the outer surface of the inner lid 20 under the action of the atmospheric pressure, so that the exhaust through hole 21 is completely closed, and the air cannot enter the pot cavity 40, the food in the pot cavity 40 is isolated from the air, thus the incubation and freshness time of the food can be lengthened.

While the present invention has been described in detail with reference to the preferred embodiments, it is to be understood that the invention is not limited to the disclosed embodiments. Those skilled in the art will appreciate that various modifications and variations can be made thereto without departing from the spirit and scope of the present invention as set forth in the appended claims.

1. A rice cooker comprising an inner pot, an inner lid, and a first elastic seal ring, the inner lid is snapped on the inner pot to enclose a pot cavity, the first elastic seal ring being disposed at a periphery of the inner lid to seal a gap between the inner lid and the inner pot when the inner lid is snapped on the inner pot, the inner lid comprising an inner surface facing the pot cavity and an outer surface disposed opposite to the inner surface, wherein the inner lid is provided with an exhaust through hole passing through the inner surface and the outer surface, the rice cooker further comprises an exhaust through hole sealing means comprising an elastic sealing disk which is attached on the outer surface of the inner lid and covers the exhaust through hole, when the difference between an internal air pressure and an external air pressure of the pot cavity is less than a first pressure difference, the elastic sealing disk seals the exhaust through hole, and when the difference is greater than the first pressure difference, the elastic sealing disk releases the sealing of the exhaust through hole.

2. The rice cooker according to claim 1, wherein the exhaust through hole sealing means further comprises a connection part respectively connected to the elastic sealing disk and the inner lid to prevent the elastic sealing disk from being disengaged from the inner lid.

3. The rice cooker according to claim 2, wherein the connection part comprises:
a connecting post which is positioned in the exhaust through hole, a vent passage being formed between the connecting post and the exhaust through hole, the elastic sealing disk being disposed on the first end of the connecting post;
a limit part which is positioned in the pot cavity and disposed on a second end of the connecting post, a distance between at least part of the outer edge of the limit part and a central axis of the exhaust through hole being greater than a radius of the exhaust through hole, and a vent port in communication with the exhaust through hole being provided between the limit part and the inner lid.

4. The rice cooker according to claim 3, wherein a clearance fit exists between the connecting post and the exhaust through hole to form a gap between the connecting post and the exhaust through hole to define the vent passage.

5. The rice cooker according to claim 3, wherein the limit part is a male ring disposed on the second end of the connecting post, a spacing which forms the vent port is provided between at least a part of the male ring closest to the surface of the inner lid and the inner surface of the inner lid.

6. The rice cooker according to claim 1, wherein the rice cooker further comprises an operating mechanism which comprises an operating part and has a non-working position and a working position, wherein,
in the non-working position, the operating part is separated from the exhaust through hole sealing means;
in the working position, the operating part cooperates with the exhaust through hole sealing means, and the elastic sealing disk releases the sealing of the exhaust through hole under the combined action of the operating part and the said air pressure difference.

7. The rice cooker according to claim 1, wherein,
the exhaust through hole sealing means further comprises a bump provided on one side of the elastic sealing disk away from the inner lid;
the rice cooker further comprises an operating mechanism which comprises an operating part and has a non-working position and a working position;
wherein,
in the non-working position, the operating part is separated from the exhaust through hole sealing means;
in the working position, the operating part is pressed against the bump of the exhaust through hole sealing means, and the bump which is under the action of the operating part and the said air pressure difference brings at least part of the separation of the elastic sealing disk from the outer surface of the inner lid and releases the sealing of the exhaust through hole.

8. The rice cooker according to claim 6, wherein the rice cooker further comprises a locking part interlinked with the operating mechanism, the locking part has a locked position and an unlocked position,
wherein,
in the locked position, the inner lid and the inner pot are in a snap-locked status, and the operating mechanism is in the non-working position;
in the unlocked position, the inner lid and the inner pot are in a released unlocked status, and the operation mechanism is in the working position.

9. The rice cooker according to claim 8, wherein the locking part comprises a button interlinked with the operating mechanism and a latch connected to and driven by the button, the button has a free status and a pressed status,
wherein,
in the free status, the locking part is in the locked position, the latch keeps the inner lid and the inner pot in the snap-locked status;
in the pressed status, the locking part in the unlocked position, the latch makes the inner lid and the inner pot to be in the released snap-locked status.

10. The rice cooker according to claim 9, wherein the operation mechanism comprises:
a first connecting rod which comprises a first end and a second end oppositely disposed and a hinge part disposed therebetween, the first connecting rod being rotatably disposed about the hinge part relative to the inner lid, wherein, the first end of the first connecting rod is disposed under the button, abutting against and cooperating with the button;
a second connecting rod which comprises a first end and a second end oppositely disposed, the first end of the second connection rod abutting against and cooperating with the second end of the first connecting rod, the second connecting rod under the driving of the second end of the first connecting rod being translatably disposed relative to the inner lid along with the rotation of the first connecting rod, wherein, the second end of the second connecting rod forms the operating part.

11. The rice cooker according to claim 10, wherein,
the second end of the first connecting rod comprises an outwardly convex curved surface;
the first end of the second connecting rod comprises a plane obliquely disposed with respect to the translation direction of the second connecting rod, the plane abutting against and cooperating with the outwardly convex curved surface.

12. The rice cooker according to claim 10, wherein the rice cooker further comprises:
an outer lid, the inner lid being connected to the inner side of the outer lid;
an exhaust valve assembly disposed on the outer lid;
a second elastic seal ring disposed between the outer lid and the inner lid and is hermetically disposed around the peripheries of the exhaust through hole, the exhaust through hole sealing means and the exhaust valve assembly, the second elastic seal ring comprising a mounting hole;
the second connecting rod and the mounting hole of the second elastic seal ring are hermetically engaged.

13. The rice cooker according to claim 12, wherein the second connecting rod comprises a fixing part disposed between the first end and the second end of the second connecting rod, the second connecting rod is hermetically fixed to the second elastic seal ring by the fixing part.

14. The rice cooker according to claim 13, wherein the fixing part comprises a first annular part and a second annular part, between which annular parts is disposed the mounting hole of the second elastic seal ring, and the first annular part and the second annular part respectively abut against the second elastic seal ring.

15. The rice cooker according to claim 6, wherein the rice cooker further comprises a reset mechanism which is drivingly connected to the operating mechanism and used for driving the operating mechanism to return to the non-working position from the working position.

16. The rice cooker according to claim 1, wherein the first elastic seal ring is configured to produce a deformation making the difference between the internal air pressure and the exterior air pressure of the pot cavity greater than the first pressure difference as the inner lid is snapped on the inner pot.

17. The rice cooker according to claim 1, wherein the first pressure difference is greater than or equal to zero.
